(19) United States
(12) Patent Application Publication
(10) Pub. No.: US 2022/0156205 A1
(43) Pub. Date: May 19, 2022

(54) METHODS AND APPARATUS TO SUPPORT POST-MANUFACTURING FIRMWARE EXTENSIONS ON COMPUTING PLATFORMS

(71) Applicant: Intel Corporation, Santa Clara, CA (US)

(72) Inventors: Subrata Banik, Bangalore (IN); Rajesh Poornachandran, Portland, OR (US); Vincent Zimmer, Issaquah, WA (US); Rajaram Regupathy, Karnataka (IN); Fadi Zuhayri, Portland, OR (US)

(21) Appl. No.: 17/483,691

(22) Filed: Sep. 23, 2021

(30) Foreign Application Priority Data
Jun. 25, 2021 (IN) 202141028575

(51) Int. Cl. G06F 13/16; G06F 12/02

(52) U.S. Cl. CPC G06F 13/1668; G06F 2212/7208; G06F 12/0246

(57) ABSTRACT

Methods, apparatus, systems, and articles of manufacture are disclosed to support post-manufacturing firmware extensions on computing platforms. An example non-transitory computer readable storage medium comprising instructions that, when executed, cause one or more processors to at least: based on a soft strap status indicator stored in a serial peripheral interface (SPI) memory, extract a silicon initialization code profile from the SPI memory and initialize the processor based on the silicon initialization code extension profile.

### FIELD OF THE DISCLOSURE

This disclosure relates generally to computing devices and, more particularly, to methods and apparatus to support post-manufacturing firmware extensions on computing platforms.

### BACKGROUND

Most computing devices utilize, low-level computing device software (e.g., basic input/output systems (BIOS) and/or unified extensible firmware interface (UEFI)) to boot up and perform low-level operation in a computer system (e.g., prior to booting of an operating system and/or user application). Boot operations managed by the low-level software perform multiple configuration actions such as configuring platform hardware such as the components of a personal computer (PC).

### BRIEF DESCRIPTION OF THE DRAWINGS

FIG. 1 illustrates an example system constructed in accordance with the teachings of this disclosure and including a user device and a silicon initializer.

FIG. 2 is a block diagram of an example silicon initialization code (SIC) to operate in the system of FIG. 1.

FIG. 3 is a block diagram of an example layout of the SPI flash memory of FIG. 1.

FIG. 4 is a block diagram of an example layout of the flash descriptor region of FIG. 3.

FIG. 5 is a block diagram of an example layout of the chipset soft strap region of FIG. 4.

FIG. 6 is a block diagram of an example layout of the SIC Extension region of FIG. 5.

FIG. 7 is a flowchart representative of machine readable instructions which may be executed by example processor circuitry to implement the user device of FIG. 1.

FIG. 8 is a flowchart representative of machine readable instructions which may be executed by example processor circuitry to implement the system of FIG. 1.

FIG. 9 is a flowchart representative of machine readable instructions which may be executed by example processor circuitry to implement the system of FIG. 1.

FIG. 10 is a flowchart representative of machine readable instructions which may be executed by example processor circuitry to implement the user device of FIG. 1.

FIG. 11 is a flowchart representative of machine readable instructions which may be executed by example processor circuitry to implement the user device of FIG. 1.

FIG. 12 is a block diagram of an example processing platform including processor circuitry structured to execute the example machine readable instructions of FIG. 7 to implement the user device of FIG. 1 and/or the silicon initialization code of FIG. 2.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 7, 8, 9, 10, and 11 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Developers of processor-based devices expect such devices to boot in a manner consistent with specifications outlined by a manufacturer of the type of processor selected by the developers. In examples related to personal computer (PCs), boot operations may be managed by basic input/output systems (BIOS), unified extensible firmware interface (UEFI), or other firmware interface. As used herein, references to “BIOS” refer to the process and/or mechanism by which a platform is booted from a previously powered-off state and any such reference may apply equally to traditional BIOS, UEFI, or any other type of firmware interface. In other words, while UEFI and other firmware interfaces are not noted throughout for simplicity, it is understood that the references to BIOS may be substituted with references to UEFI and/or any other type of firmware interface. Generally speaking, boot operations occur immediately after power is applied to a platform, but prior to an operational point where an operating system (OS) has control of that platform. The boot operations initialize platform hardware (e.g., memory, buses, drives, keyboards, displays, etc.) so that such hardware is in a state to be handed-off to the OS.

While the PC industry has a mature market for BIOS vendors, in some examples, customizing the BIOS involves engaging BIOS vendors for development expertise and/or licensing to use one or more BIOS solution(s). Even in circumstances where a BIOS vendor agrees to license one or more solutions to facilitate platform booting, such solutions may remain proprietary, thereby leaving the platform developer with a degree of dependence upon outside expertise rather than a controlled and/or otherwise fully owned platform solution.

The platform developer is typically knowledgeable of key aspects of the platform being developed, particularly with regard to on-board sensors and/or devices. However, many platform developers still rely on third party vendors for processing resources (e.g., processors, microprocessors, microcontrollers and/or, more generally, processing silicon). While the platform developers may have expertise in most aspects of their platform, gaining similar expertise and/or knowledge regarding the processing resources and/or processing resource initialization requirements may require adherence to voluminous and/or complicated processing vendor specifications and manuals.

To relinquish valuable developer development time, silicon initialization code (SIC) components (e.g., binaries, application programming interfaces (APIs)) facilitate a focused configuration effort of processing resources of a platform. In some examples, the SIC components are associated with the Intel® Firmware Support Package (FSP). Rather than require the developer to become an expert in third party processing resources, the SIC components allow the processing resources to be properly initialized during a booting phase of the platform through a bootloader (e.g., coreboot or EDK II). Upon completion of processing resource initialization via the SIC components, developer-specific boot instructions may be implemented to continue with initialization of one or more other portions of the platform for which the developer likely has expertise.

The boot operations for a PC configure hardware of the PC including: controlling settings such as clock speed and ring speed, enabling or disabling hardware component ports such as those containing video cards or graphics cards, enabling or disabling hyperthreading, etc. Typically, these BIOS (or other low level operation) settings can only be modified via a setup screen which allows a user to enable or disable a feature. The setup screen may only contain a subset of the features and settings controlled by the BIOS, thus limiting the user's ability to customize their platform for their usage needs. Furthermore, some platforms do not contain a BIOS setup infrastructure making platform configuration even more challenging. While it would be possible for an OEM to distribute an updated BIOS for end-user usage needs, such process is expensive and, therefore, BIOS updates by an OEM are typically limited during the life of a platform.

Because early initialization software can have a tightly coupled binding to underlying processor hardware, the silicon manufacturer may provide early initialization software (e.g., SIC), rather than it being implemented by the OEM BIOS. The SIC may be used in an environment to load code, guarantee its provenance, and after execution of the SIC, hand control off to OEM BIOS in a seamless fashion. The SIC may be used to perform low level aspects of memory initialization (e.g., training and diagnostics), key initialization code for memory controllers and interconnect links, as well as potentially provide runtime support for various processor and system features.

Examples disclosed herein facilitate firmware updates and/or configuration to allow for customization of a platform according to user needs (e.g., after a computing device has left a manufacturer). In some examples, silicon reference policies within an SIC can be dynamically controlled. In some examples, the serial peripheral interface (SPI) flash image can be modified to control hardware configuration policies. In examples disclosed herein, platform configuration can occur without altering the BIOS portion of the SPI flash (e.g., without the need for deploying a new version of the BIOS, UEFI, and/or firmware interface). In some examples, a cloud service (e.g., an applet store) can facilitate distribution of applets, applications, modules, etc. that may be retrieved to a computing platform and may operate to configure the platform without modifying BIOS code after the platform leaves a manufacturer.

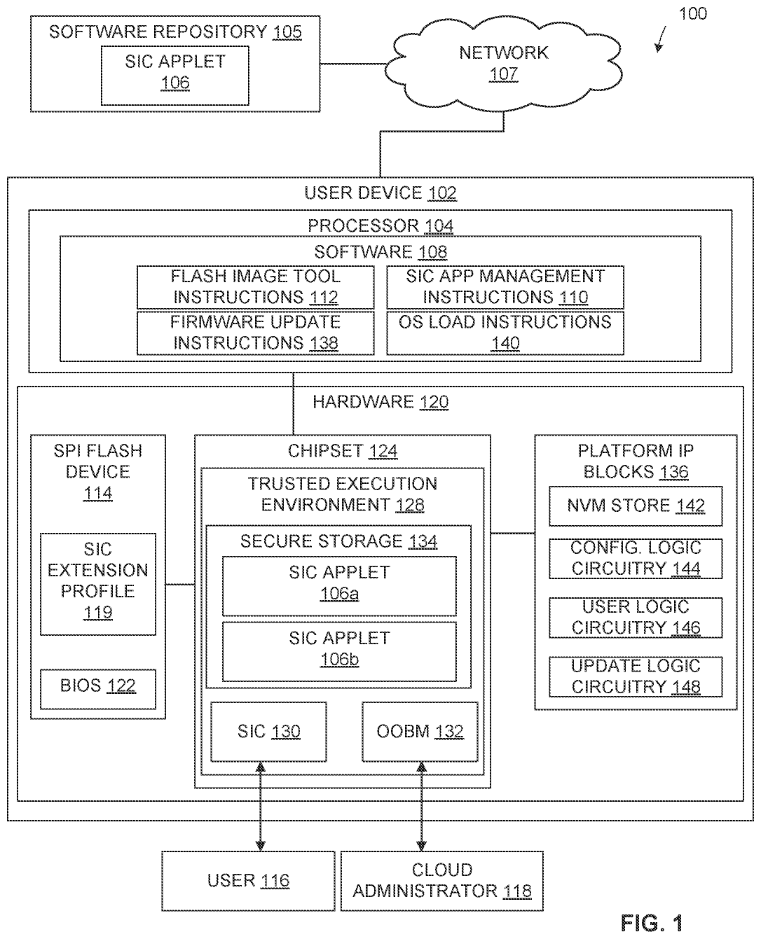

FIG. 1 illustrates an example system 100 constructed in accordance with the teachings of this disclosure and including a user device 102. The user device 102 is communicatively coupled to a software repository 105 via a network 107. The example software repository 105 of FIG. 1 provides means for hosting SIC applets 106. The SIC applets 106 can be provided to the software repository 105 by one or more of a silicon manufacturer, an operating system (OS) vendor, and/or a third-party SIC applet developer.

The example user device 102 can be a personal computing (PC) device (e.g., laptop, desktop, electronic tablet, a hybrid or convertible PC, etc.), a server computing device, or any other type of computing device. In some examples, the user device 102 includes a mobile device such as a smartphone.

In the illustrated example of FIG. 1, the user device 102 includes a processor 104. The processor 104 of the example user device 102 of FIG. 1 includes a software portion 108. The example software portion 108 includes storage devices (not shown) storing user applications. One example user application is SIC app management instructions 110. The SIC app management instructions 110 provide means for managing SIC applets 106. For example, the SIC app management instructions 110 can download an SIC applet 106 from the software repository 105. The SIC app management instructions 110 can download an SIC applet 106 in response to a request (e.g., from a user 116 or a cloud administrator 118). In some examples, the SIC app management instructions 110 provide a graphical user interface (GUI) with which a user 116 can interact. In other examples, the user 116 and/or the cloud administrator 118 can interact with the SIC app manager via command line instructions. In some examples, the SIC app management instructions 110 download one SIC applet 106. In other examples, the SIC app management instructions 110 download a plurality of SIC applets 106. The SIC app management instructions 110 can store the downloaded SIC applet(s) 106 in the user device 102. The storage location of the SIC applet(s) can be inside and/or outside the processor 104.

The example SIC app management instructions 110 of FIG. 1 send a notification to other components of the user device 102 indicating that the SIC applet 106 is available. For example, the notification may include a status of the SIC applet 106 and a storage location of the SIC applet 106 in the user device 102. In some examples, the notification is sent in response to an initial download of the SIC applet 106. In other examples, the notification may be sent in response to input (e.g., due to a request from a user 116 or from a cloud administrator 118).

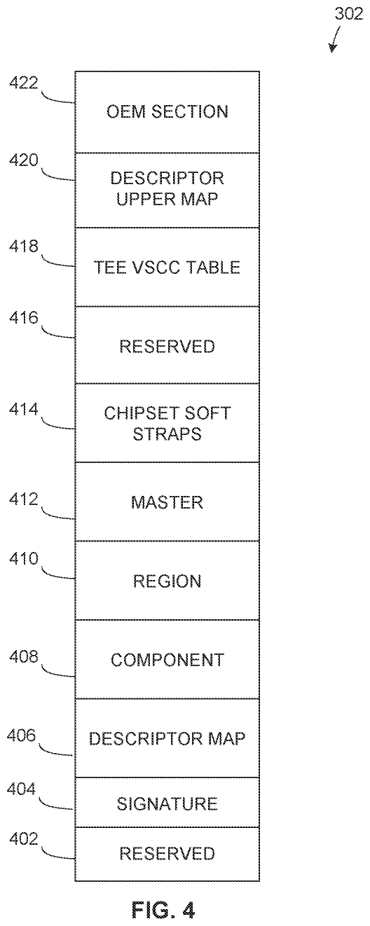

The example user device 102 of FIG. 1 includes a hardware portion 120. The example hardware portion 120 includes one or more processors, memories, input/output devices, etc. The example hardware portion 120 contains one or more serial peripheral interface (SPI) flash device(s) 114. In some examples, the SPI flash device(s) 114 are non-volatile memory such as an electrically erasable and programmable read only memory (EEPROM). A layout of the example SPI flash device 114 is described below in conjunction with FIG. 4. Contents of the SPI flash device 114 can be based on an image file (e.g., the IFWI). The example SPI flash device 114 of FIG. 1 is used to perform boot operations of the user device 102. In the example of FIG. 1, the SPI flash device 114 includes a BIOS 122.

The example SPI flash device 114 includes an SIC extension profile 119. The example SIC extension profile 119 is one byte of memory containing bits corresponding to SIC extension profile status, debug profile mode, boot mode, low power mode profile status, gaming mode profile status, performance mode profile status, etc.

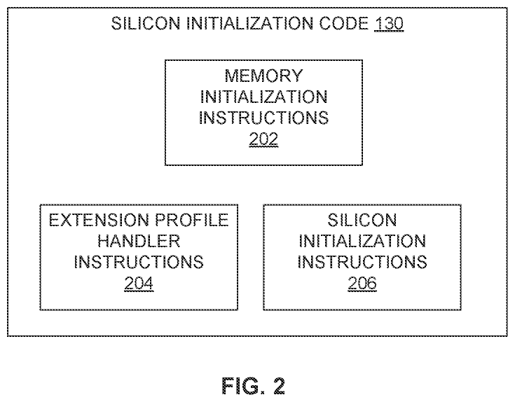

The example hardware includes a chipset 124. The chipset 124 is in communication with the SPI flash device(s) 114 and a processor 126 (e.g., a central processing unit (CPU)). Interface circuitry (not shown) may provide access to the SPI flash device(s) 114 from the chipset 124 or any other hardware or software component of the user device 102. In some examples, the chipset 124 is a Platform Controller Hub (PCH). The example chipset 124 includes a trusted execution environment 128. In some examples, the trusted execution environment 128 is an Intel® Management Engine (ME). The trusted execution environment 128 includes silicon initialization code (SIC) 130. In other examples, the SIC 130 can be located on a SPI flash device (e.g., SPI flash device 114 of FIG. 1) and/or anywhere else in the hardware 120 of the user device 102. The example SIC 130 is platform independent code (e.g., can be executed on any given platform regardless of the specific of the machine) whereas the example BIOS 122 which is platform dependent. During boot operations, the example SIC 130 initializes memory and/or silicon components (e.g., processors, etc.) of the user device 102. In some examples, the SIC 130 is a Firmware Support Package (FSP). Components of the example SIC 130 are described in further detail below in conjunction with FIG. 2.

The trusted execution environment 128 includes an out of band manager (OOBM) 132. The OOBM 132 allows remote hardware and firmware management of the user device 102. For example, a cloud administrator 118 can perform management activity (e.g., power up, power down, block network traffic, etc.) on the user device 102 remotely via the OOBM 132. In some examples, the OOBM 132 is Active Management Technology (AMT). The trusted execution environment 128 of FIG. 1 includes a secure storage 134. The example secure storage 134 stores one or more SIC applet(s) 106 such as SIC applet 106a and SIC applet 106b.

Returning to the software portion 108, the user device 102 of FIG. 1 includes flash image tool instructions 112. The flash image tool instructions 112 configure and creates a firmware image. For example, the flash image tool instructions 112 can create an integrated firmware image (IFWI) which can be used for configuring the SPI flash device 114. The flash image tool instructions 112 configure settings of the firmware image (e.g., IFWI). In some examples, the SIC applet 106 downloaded by the SIC app management instructions 110 has provision to override one or more of the settings of the firmware image within the flash image tool instructions 112. In some examples, the SIC applet 106 overrides the settings during runtime operation (e.g., after boot operations) of the user device 102. In other examples, the example flash image tool instructions 112 can configure the settings of the firmware image based on input (e.g., by a user 116 and/or a cloud administrator 118).

The example software portion 108 of the user device 102 includes firmware update instructions 138. The example firmware update instructions 138 flash an image (e.g., IFWI) to the SPI flash device 114. The example software portion 108 of the user device 102 includes operating system (OS) load instructions 140. In some examples, the firmware update instructions 138 flash the image (e.g., IFWI) onto the SPI flash device 114 in response to instructions from the OS load instructions 140.

The example hardware of FIG. 1 includes platform intellectual property (IP) blocks 136 (e.g., NVM store 142, configuration logic circuitry 144, user logic circuitry 146, update logic circuitry 148, etc.). The example platform IP blocks 136 provide a reusable unit of logic, cell, or integrated circuit layout. For example, the BIOS 122 and/or the SIC 130 can initialize the platform IP blocks 136 during boot operations to initialize silicon components (e.g., CPU, companion chips, etc.).

In some examples, the platform IP blocks 136 are located within the processor 104. In other examples, the platform IP blocks 136 are located outside of the processor 104. In some examples, the platform IP blocks 136 are provided by the silicon manufacturer. In other examples, the platform IP blocks 136 are provided by a third-party.

FIG. 2 is a block diagram of an example implementation of the SIC 130 to operate in the system of FIG. 1. The example SIC 130 of FIG. 2 includes example memory initialization instructions 202, example extension profile handler instructions 204, and example silicon initialization instructions 206.

The example memory initialization instructions 202 initialize temporary and/or permanent memory and/or performs early silicon initialization. For example, during boot operations, a bootloader may pass control to the SIC as per standard flow. The example memory initialization instructions 202 then perform memory initialization steps (e.g., setting up memory addressing).

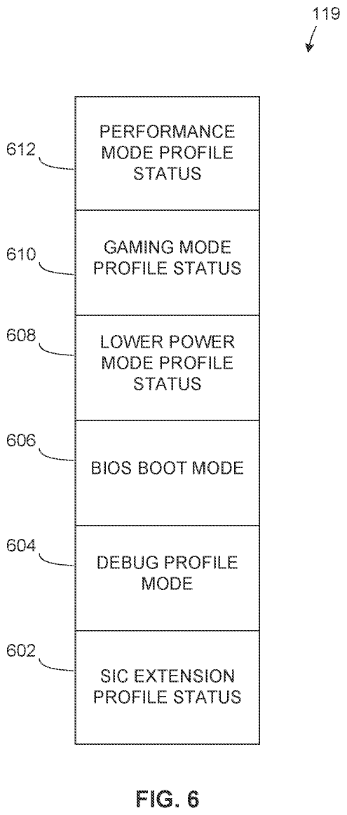

The example extension profile handler instructions 204 retrieve an SIC extension profile 119. For example, during boot operations after the SIC 130 has received platform control, the extension profile handler instructions 204 read the SPI flash 114 to obtain the SIC extension profile 119. The example extension profile handler instructions 204 update hardware configuration based on the SIC extension profile 119 as discussed below in conjunction with FIG. 6. The example extension profile handler instructions 204 read the SIC extension profile 119 to determine the status of hardware and/or boot modes as set by the SIC extension profile 119. For example, the extension profile handler instructions 204 can determine a bit in the SIC extension profile 119 corresponding to an SIC extension profile status is set to 1 (e.g., enable). In some of these examples, the extension profile handler instructions 204 can determine a bit in the SIC extension profile 119 corresponding to a profile status (e.g., lower power mode profile status, gaming mode profile status, performance mode profile status, etc.) is set to 1 (e.g., enable). Based on the hardware and/or boot modes set in the SIC extension profile, the example extension profile handler instructions 204 set hardware configuration settings within the SIC 130.

The example silicon initialization instructions 206 initialize silicon components (e.g., processor 126, graphics processing units (GPUs), etc.) of the user device 102. In some examples, the silicon initialization instructions 206 initialize the silicon components (e.g., processor 126, GPUs, etc.) based on the SIC extension profile 119. For example, if the profile reader determines that the SIC extension profile status is set to enable and the low power mode profile status is set to enable, the silicon initializer uses the hardware settings configured by the extension profile handler instructions 204 to initialize the silicon components (e.g., processor 126, GPUs, etc.) of the user device 102.

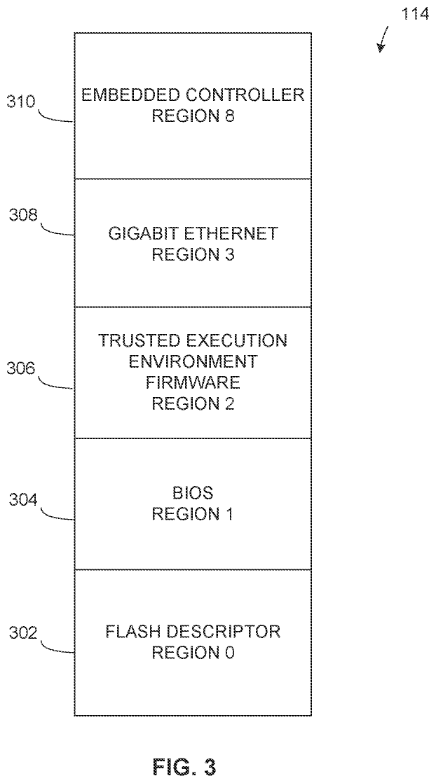

FIG. 3 is a block diagram of an example layout of the SPI flash device 114 of FIG. 1. The example SPI flash device 114 includes a flash descriptor region 302. The example flash descriptor region 302 includes a description of the layout of the SPI flash device 114 and/or configuration parameters for the user device 102. The example SPI flash 114 device includes a BIOS region 304. In other examples, the BIOS is located on a separate flash device from SPI flash device 114. In some examples, the BIOS region 304 includes the SIC130. The example SPI flash device 114 includes a trusted execution environment firmware region 306. The example SPI flash device 114 includes additional regions such as a gigabit ethernet (GbE) region 308, an embedded controller region 310, and/or any other regions. In some examples, one or more of the above regions is omitted from the SPI flash device 114.

FIG. 4 is a block diagram of an example layout of the flash descriptor region 320 of FIG. 3. The example flash descriptor region 320 as illustrated in FIG. 4 includes one or more reserved regions 402 and 416, a signature region 404, a descriptor map region 406, a component region 408, a region 410, a master region 412, a chipset soft strap region 414, a trusted execution environment vendor-specific component capabilities (TEE VSCC) table 418, a descriptor upper map region 420, and an OEM section 422. In some examples, the flash descriptor region 320 includes regions not displayed in FIG. 4. In some examples, not all the regions displayed in FIG. 4 are included in the flash descriptor region 320. The example chipset soft strap region 414 includes configurable option selections that are loaded into the chipset 124 during boot operations.

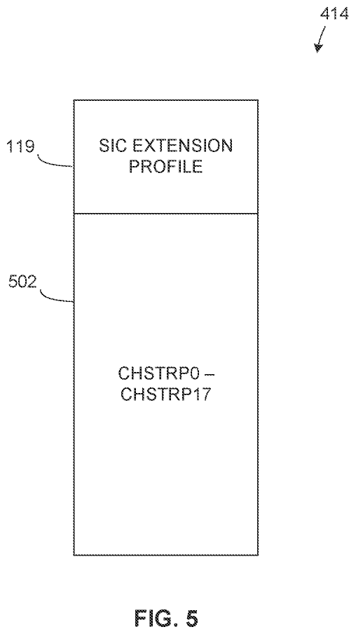

FIG. 5 is a block diagram of an example layout of the chipset soft strap region 414 of FIG. 4. The chipset soft strap region 414 illustrated in FIG. 5 includes a first region 502 including chipset strap records (CHSTRP) 0-17. The example chipset soft strap region 414 of FIG. 5 also includes the SIC extension profile 119 as discussed above in conjunction with FIG. 2. As explained above, the example extension profile handler instructions 204 find, read, and extract one or more SIC extensions from the SIC extension profile 119 during boot operations.

FIG. 6 is a block diagram of an example layout of the SIC extension profile 119 of FIG. 5. In the example of FIG. 6, the SIC extension profile 119 is 1 byte in width. In other examples, the SIC extension profile 119 may be larger or smaller than one 1 byte. The example SIC extension profile 119 includes an example SIC extension profile status region 602, an example debug profile mode 604, an example BIOS boot mode 606, an example lower power mode profile status 608, an example gaming mode profile status 610, and an example performance mode profile status 612.

The SIC extension profile status region 602 of FIG. 6 includes 1 bit wherein a setting of 0 corresponds to disable and a setting of 1 corresponds to enable. For example, if the SIC extension profile status region 602 is set to 0 (e.g., disable), hardware configuration based on the SIC extension 119 is disabled. Alternatively, if the SIC extension profile status region 602 is set to 1 (e.g., enable), hardware configuration based on the SIC extension 119 is enabled. In one example, a default value of the SIC extension profile status region 602 is 0 (e.g., disable).

The example debug profile mode region 604 illustrated in FIG. 6 includes 3 bits corresponding to debug settings (e.g., CPU, memory, chipset, TBT/USB4, etc.). For example, if the debug profile mode region 604 is set to 000, CPU is selected for debug. In another example, if the debug region is set to 001, memory is set for debug.

The example BIOS boot mode region 606 of FIG. 1 includes 1 bit wherein a setting of 0 corresponds to release and a setting of 1 corresponds to debug. For example, if the BIOS boot mode region 606 is set to 1 (e.g., debug), the BIOS 122 boots into debug mode corresponding to the component indicated by the debug profile mode 604 (e.g., CPU). In another example, the BIOS boot mode region 606 is set to 0 (e.g., release). In this example, the BIOS 122 does not boot into debug mode. In one example, a default value of the BIOS boot mode region 606 is 0 (e.g., release).

In the example of FIG. 6, the SIC extension profile 119 includes multiple profile status indicates for selecting to enable various customizable configurations: the lower power mode profile status region 608, the gaming mode profile status region 610, and the performance mode profile status region 612. In other examples, profile status regions corresponding to alternative modes can be included alternatively and/or additionally to the ones included in FIG. 6. For example, the example SIC extension profile 119 can contain regions corresponding to profile status for modes that are different than those represented in FIG. 6 (e.g., video conferencing mode, low temperature mode, quiet mode, dark mode, bright mode, etc.).

The profile status regions of the SIC extension profile 119 (e.g., the lower power mode profile status region 608, the gaming mode profile status region 610, and the performance mode profile status region 612) include 1 bit wherein a setting of 0 corresponds to disable and a setting of 1 corresponds to enable. For example, if the gaming mode profile status region 610 is set to 0 (e.g., disable), hardware configuration based on the gaming mode profile is disabled. Alternatively, if the gaming mode profile status region 610 is set to 1 (e.g., enable) and the SIC extension profile status region 602 is set to 1 (e.g., enable), the SIC configures the hardware based on a gaming mode profile (e.g., setting parameters that correspond to increasing performance related to gaming). In one example, a default value of the profile status regions 608, 610, and 612 is 0 (e.g., disable).

As explained above in conjunction with FIG. 1, the example SIC applet 106 downloaded by the SIC app management instructions 110 has provision to override one or more of the settings (e.g., factory settings) of the firmware image via the flash image tool instructions 112. In the illustrated example, the SIC applet 106 has provision to override one or more of the settings of the SIC extension profile 119. For example, the SIC applet 106 can modify the gaming mode profile status region 610 to 1 (e.g., enable) and the SIC extension profile status region 602 to 1 (e.g., enable) within the flash image tool instructions 112. Once the updated flash image is loaded onto the SPI flash device 114, the hardware of the user device 102 is configured based on the updated SIC extension profile 119.

While the illustrated examples utilize a value of 1 for enable and 0 for disable, any other arrangement or values may be utilized to indicate enable or disable.

While an example manner of implementing the user device 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example processor 104, the example SIC app management instructions 110, the example flash image tool instructions 112, the example firmware update instructions 138, the example OS load instructions 140, the example SIC 130, and/or, more generally, the example user device 102 of FIG. 1, may be implemented by hardware, software, firmware, and/or any combination of hardware, software, and/or firmware. Thus, for example, any of the example processor 104, the example SIC app management instructions 110, the example flash image tool instructions 112, the example firmware update instructions 138, the example OS load instructions 140, the example SIC 130, and/or, more generally, the example user device 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example processor 104, the example SIC app management instructions 110, the example flash image tool instructions 112, the example firmware update instructions 138, the example OS load instructions 140, and/or the example SIC 130 is/are hereby expressly defined to include a non-transitory computer readable storage device or storage disk such as a memory, a digital versatile disk (DVD), a compact disk (CD), a Blu-ray disk, etc., including the software and/or firmware. Further still, the example user device 102 of FIG. 1 may include one or more elements, processes, and/or devices in addition to, or instead of, those illustrated in FIG. 1, and/or may include more than one of any or all of the illustrated elements, processes and devices.

While an example manner of implementing the SIC 130 of FIG. 1 is illustrated in FIG. 2, one or more of the elements, processes, and/or devices illustrated in FIG. 2 may be combined, divided, re-arranged, omitted, eliminated, and/or implemented in any other way. Further, the example memory initialization instructions 202, the example extension profile handler instructions 204, the example silicon initialization instructions 206 and/or, more generally, the example SIC 130 of FIG. 1, may be implemented by hardware, software, firmware, and/or any combination of hardware, software, and/or firmware. Thus, for example, any of the example memory initialization instructions 202, the example extension profile handler instructions 204, the example silicon initialization instructions 206, and/or, more generally, the example SIC 130, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example memory initialization instructions 202, the example extension profile handler instructions 204, and/or the example silicon initialization instructions 206 is/are hereby expressly defined to include a non-transitory computer readable storage device or storage disk such as a memory, a digital versatile disk (DVD), a compact disk (CD), a Blu-ray disk, etc., including the software and/or firmware. Further still, the example SIC 130 of FIG. 1 may include one or more elements, processes, and/or devices in addition to, or instead of, those illustrated in FIG. 2, and/or may include more than one of any or all of the illustrated elements, processes and devices.

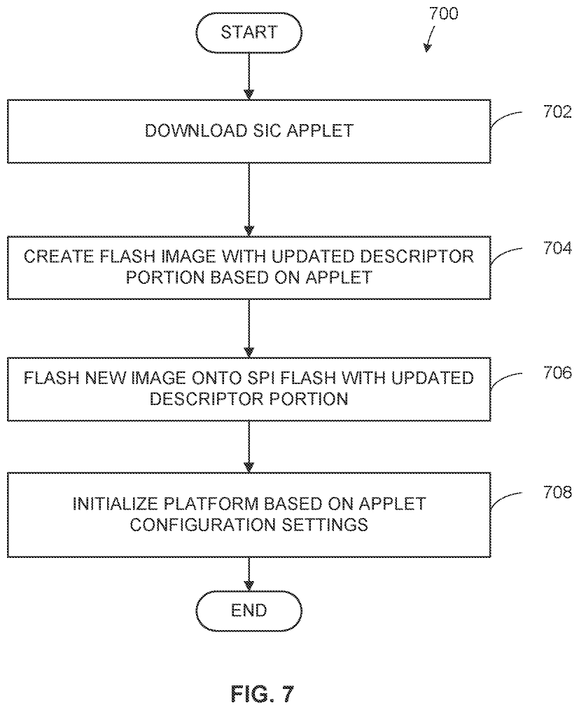

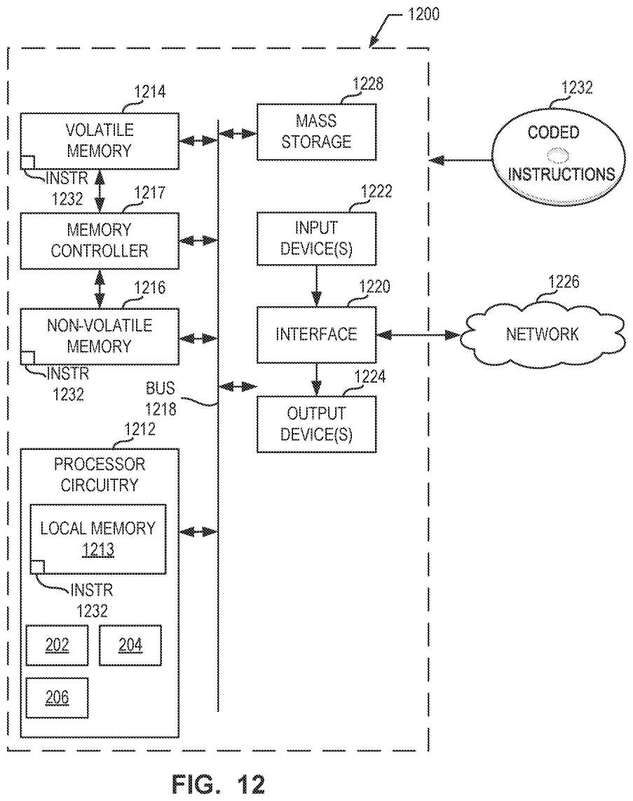

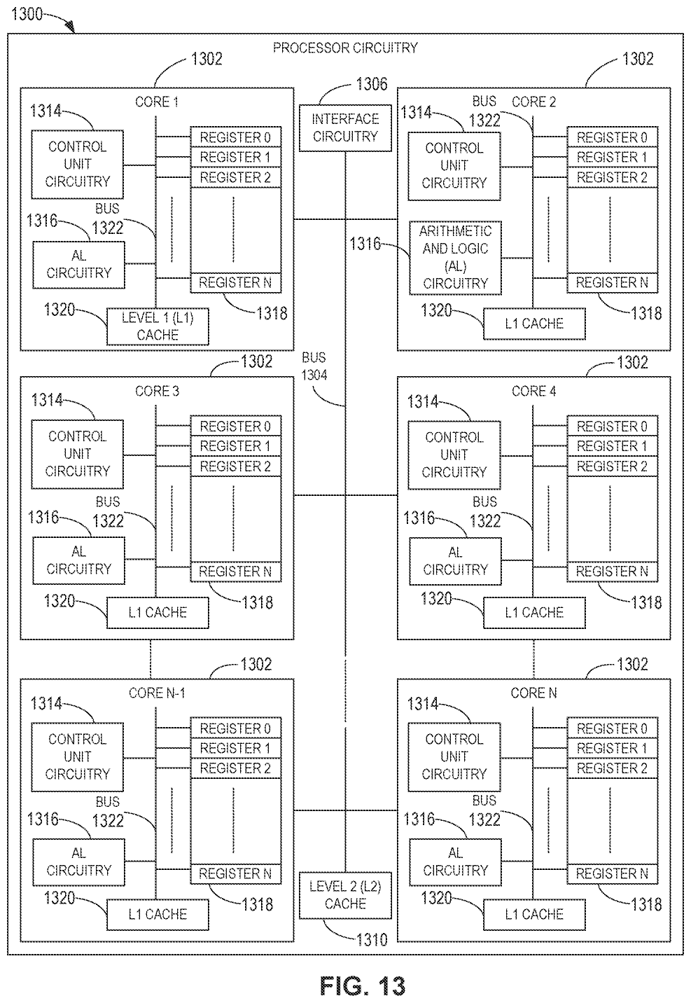

Flowcharts representative of example hardware logic circuitry, machine readable instructions, hardware implemented state machines, and/or any combination thereof for implementing the user device 102 of FIG. 1 are shown in FIGS. 7-11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7-11, many other methods of implementing the example user device 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7, 8, 9, 10, and 11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to configure platform hardware without modifying the BIOS. The machine readable instructions and/or operations 700 of FIG. 7 begin at block 702, at which the SIC app management instructions 110 download an SIC applet 106 from the software repository 105. For example, the SIC app management instructions 110 download an SIC applet 106 corresponding to hardware settings to configure the device platform into a lower power mode. At block 704, in response to the applet download, the flash image tool instructions 112 updates the flash descriptor region 302 setting of a flash image and creates a flash image based on the updated descriptor portion. For example, in response to the download of the lower power mode applet, the flash image tool instructions 112 can set a profile status region (e.g., lower power mode profile status region 608) of the chipset soft strap region 414 in the flash descriptor region 302 to 1 (e.g., enable). Further, the flash image tool instructions 112 create an IFWI including the updated flash descriptor region 302. In the updated IFWI, only the flash descriptor region 302 is modified. The additional regions (e.g., the BIOS region 304) of the IFWI remain unchanged. In some examples, the IFWI is included in a UEFI capsule.

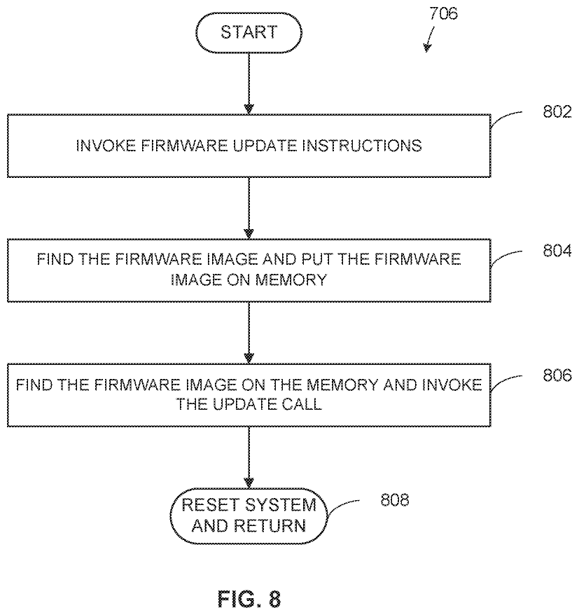

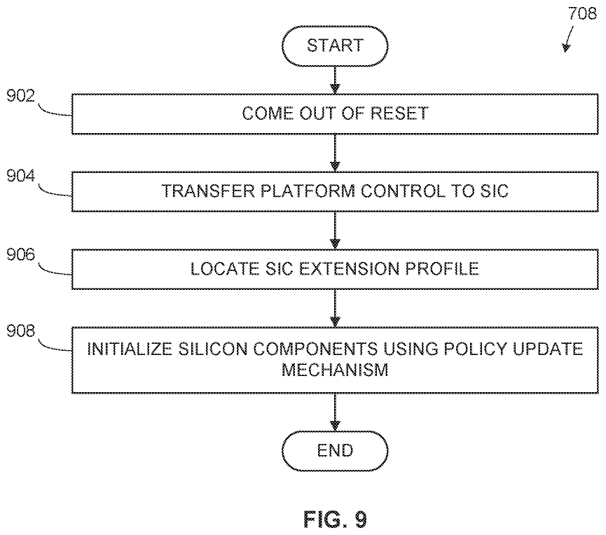

At block 706, the firmware update instructions 138 flash the updated flash image including the updated flash descriptor region 302 onto the SPI flash device 114 as described in more detail below in conjunction with FIG. 8. At block 708, the SIC 130 initializes the platform hardware based on SIC applet 106 configuration settings as described in more detail below in conjunction with FIGS. 9, 10 and 11.

FIG. 8 is a flowchart representative of example machine readable instructions and/or example operations 706 that may be executed and/or instantiated by processor circuitry to update the flash image on the SPI flash device 114. The illustrated example of FIG. 8 represents a firmware image update mechanism based on UEFI capsules. In other examples, another firmware update mechanism can be implemented to flash the SPI flash device 114.

At block 802, the firmware update instructions 138 are invoked by the processor 104. In some examples, the firmware update instructions 138 are invoked in response to the creation of the updated IFWI by the flash image tool instructions 112. In some examples, the firmware update instructions 138 are a UEFI service (e.g., UpdateCapsule). In some examples, the firmware update instructions 138 are invoked during runtime (e.g., after boot operations). In the illustrated example, the system is reset after the firmware update instructions 138 are invoked. At block 804, the OS load instructions 140 locate the firmware image (e.g., IFWI and/or UEFI capsule) and puts the firmware image (e.g., IFWI and/or UEFI capsule) on memory. In some examples, the system is reset after the OS load instructions 140 put the firmware image on the memory. At block 806, the OS load instructions 140 find the firmware image (e.g., IFWI and/or UEFI capsule) and invokes an update call. For example, the OS load instructions 140 locate the IFWI including the updated flash descriptor region 302 and invoke the firmware update instructions 138 based on the location of the IFWI. The firmware update instructions 138 flash the updated IFWI onto the SPI flash device 114, thus updating the flash descriptor region 302 of the SPI flash device 114. At block 808, the system performs a reset and the flow passes back to block 708 of FIG. 7.

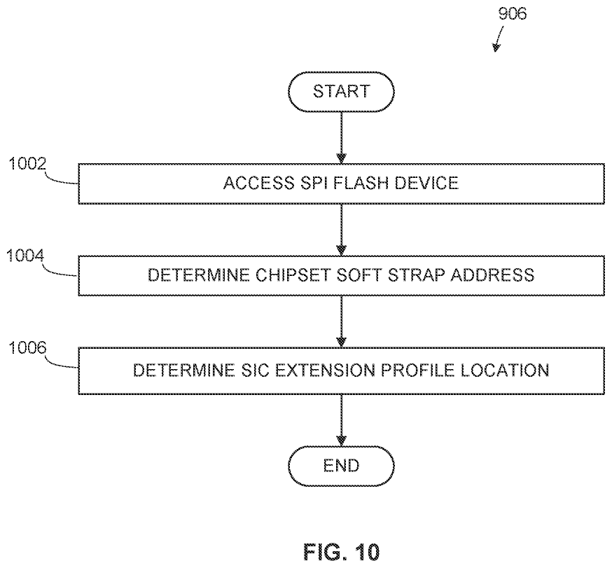

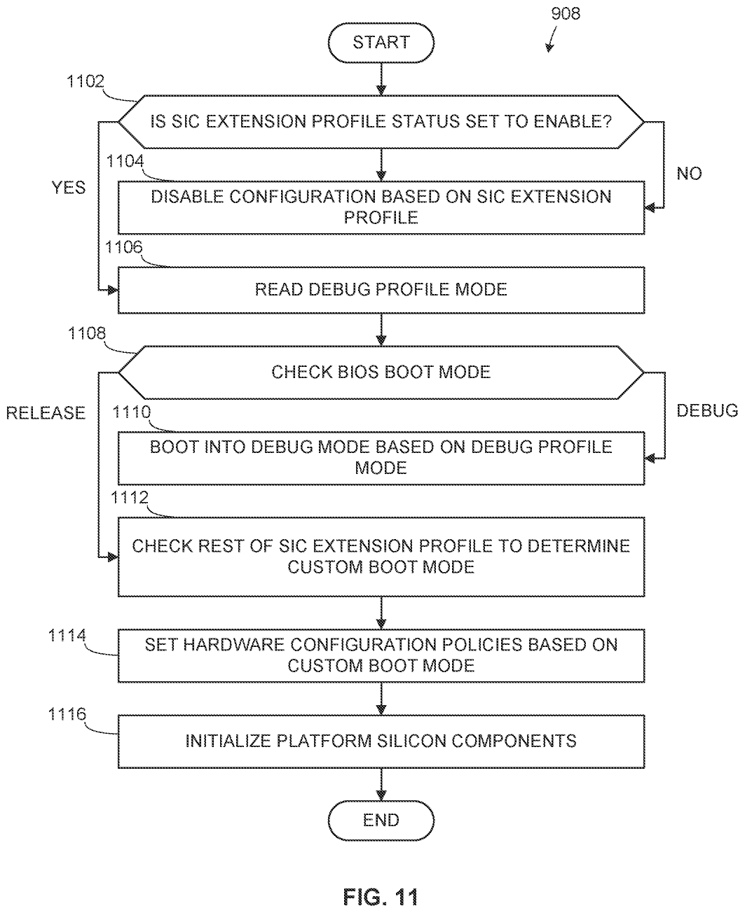

FIG. 9 is a flowchart representative of example machine readable instructions and/or example operations 708 that may be executed and/or instantiated by processor circuitry to initialize the platform based on the SIC applet 106. At block 902, power is applied to the user device 102 and the user device 102 comes out of reset. At block 904, the SIC 130 receives control of the platform. For example, after the user device 102 comes out of reset, core microcode or other logic in the processor 104 may locate the SIC 103 and transfer platform control to the SIC 103 to continue boot operations. In some examples, the example memory initialization instructions 202 perform temporary and/or non-temporary memory initialization. At block 906, the example extension profile handler instructions 204 locate the SIC extension profile 119 as discussed below in further detail in conjunction with FIG. 10. At block 908, the silicon initialization instructions 206 of the SIC 130 initialize platform silicon components based on the policies set in the SIC extension profile 119 as discussed below in further detail in conjunction with FIG. 11.

FIG. 10 is a flowchart representative of example machine readable instructions and/or example operations 908 that may be executed and/or instantiated by processor circuitry to locate the SIC extension profile 119. At block 1002, the SIC 130 accesses the SPI flash device 114. For example, the SIC 130 uses a structure such as a pre-EFI initialization module (PEIM)-to-PEIM interface (PPI) to communicate with the SPI flash device 114. At block 1004, the extension profile handler instructions 204 read the flash descriptor region 302 of the SPI flash device 114 to determine the location of the chipset soft strap region 414 on the SPI flash device 114. For example, the extension profile handler instructions 204 read the descriptor map portion 406 of the flash descriptor region 302. The example descriptor map portion 406 contains the location of the chipset soft strap region 414. In some examples, the chipset soft strap region 414 is stored in a different location within the flash descriptor region 302. At block 1006, the extension profile handler instructions 204 determine the location of the SIC extension profile 119 within the flash descriptor region 302. For example, the extension profile handler instructions 204 add a known offset corresponding to the SIC extension profile 119 to the location indicating the start of the chipset soft strap region 414.

FIG. 11 is a flowchart representative of example machine readable instructions and/or example operations 908 that may be executed and/or instantiated by processor circuitry to initialize the user device 102 based on the SIC applet 106. At block 1102, the extension profile handler instructions 204 check the SIC extension profile status region 602 of the SIC extension profile 119. If the SIC extension profile status region 602 is set to 0 (e.g., disable), configuration of the hardware based on the SIC extension profile 119 is disabled (block 1104). If the SIC extension profile status region 602 is set to 1 (e.g., enable), the extension profile handler instructions 204 continue reading the SIC extension profile 119 to determine hardware configuration settings. At block 1106, the extension profile handler instructions 204 read the debug profile mode region 604 to determine a selected component for debug. For example, if the debug profile mode region 604 is set to 000, CPU is selected for debug. At block 1108, the extension profile handler instructions 204 read the BIOS boot mode region 606. If the BIOS boot mode region 606 is set to 1 (e.g., debug), the platform is booted into debug mode using the selected component of the debug profile mode 604 (block 1110). If the BIOS boot mode region 606 is set to 0 (e.g., release), the extension profile handler instructions 204 continue checking the SIC extension profile 119 to determine a custom boot mode which is set to enable (block 1112). For example, the extension profile handler instructions 204 can determine that the gaming mode profile status region 610 is set to 1 (e.g., enable). At block 1114, the extension profile handler instructions 204 set hardware configuration policies based on the enabled custom boot mode. For example, the extension profile handler instructions 204 use the below pseudocode to set hardware settings.

At block 1116, the silicon initialization instructions 206 initialize the silicon components (e.g., processor 126, GPUs, etc.) of the user device 102 based on the hardware configuration of block 1114. For example, the silicon initialization instructions 206 use the platform IP block 136 logic to initialize the processor 104 and/or other silicon components of the user device 102.

```
EFI_STATUS Status;
UINT8 BiosSoftStrap;
Status = SpiPpi->ReadPchSoftStrap (
    SpiPpi,
    0xA8, // Offset for BIOS Profile
    1, // 1-byte in size
    BiosSoftStrap
  );
if ((BiosSoftStrap & BIT (0))) {
  if ((BiosSoftStrap & BIT (5))) {// Lower power mode is set to enable.
    FSPM_CONFIG->SaTestLowPwrMode= 1;
    FSPS_CONFIG->PmcLpmS0ixSubStateEnableMask= 0xFF;
    FSPM_CONFIG->PrimaryDisplay= 0; // iGFX Only display
    FSPM_CONFIG->HgSlot= 0; // Disable Hybrid GFX PCIE port
  } else if ((BiosSoftStrap & BIT (6))) {// Gaming mode is set to enable.
    FSPM_CONFIG->PrimaryDisplay= 4; // Hybrid GFX Only display
    FSPM_CONFIG->HgSlot= 1; // Enable Hybrid GFX PCIE port
    FSPM_CONFIG->CoreMaxOcRatio= 0x53;
    FSPM_CONFIG->RingMaxOcRatio= 0x53;
  } else if ((BiosSoftStrap & BIT (7))) {// Performance mode is set to
  enable.
    FSPM_CONFIG->CoreMaxOcRatio= 0x53;
    FSPM_CONFIG->RingMaxOcRatio= 0x53;
    FSPM_CONFIG->HyperThreading= 0x1;
    FSPM_CONFIG->CpuRatioOverride= 0x1;
    FSPM_CONFIG->CpuRatio= 0x1C; // Max HFM
    FSPM_CONFIG->BootFrequency= 2; // Turbo performance
    FSPM_CONFIG->FClkFrequency= 1; // 1 GHZ or max for the
  segment
  }
}
```

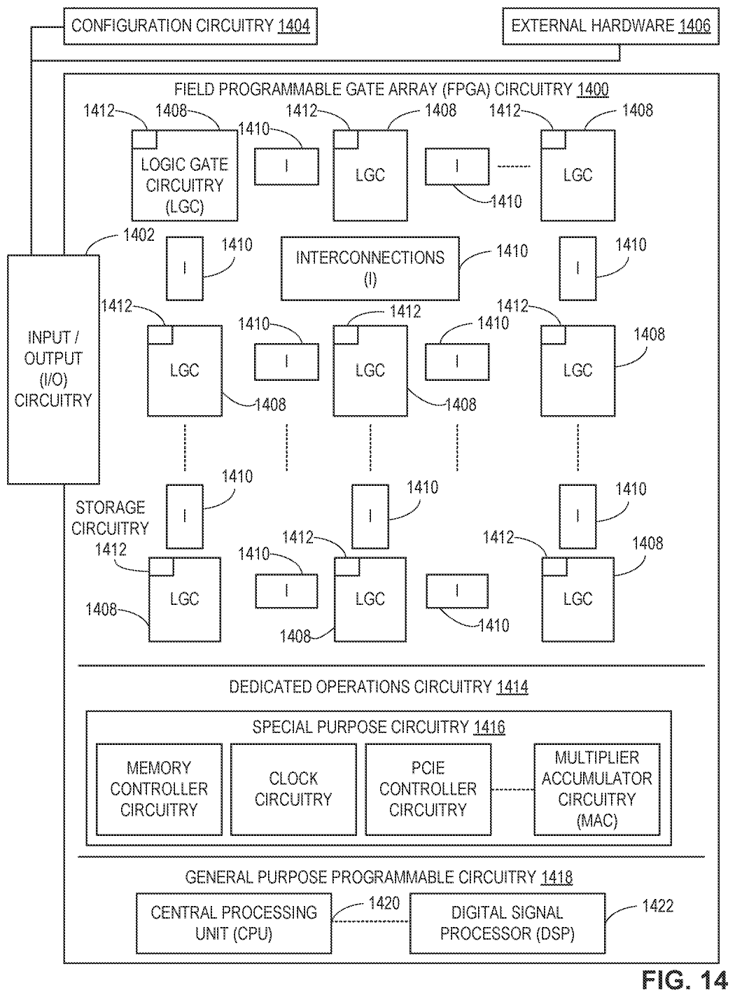

In some examples, the apparatus includes means for extracting the SIC extension profile 119 from the SPI flash device 114. For example, the means for extracting may be implemented by the extension profile handler instructions 204. In some examples, the extension profile handler instructions 204 may be implemented by machine executable instructions such as that implemented by at least blocks 708 of FIG. 7, 906 of FIG. 9, 1002, 1004, 1006 of FIG. 10, 1102, 1104, 1106, 1108, 1110, 1112, 1114 of FIG. 11, executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the extension profile handler instructions 204 are implemented by other hardware logic circuitry, hardware implemented state machines, and/or any other combination of hardware, software, and/or firmware. For example, the extension profile handler instructions 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for initializing a processor based on the SIC extension profile 119. For example, the means for initializing may be implemented by the silicon initialization instructions 206. In some examples, the silicon initialization instructions 206 may be implemented by machine executable instructions such as that implemented by at least blocks 708 of FIG. 7, 908 of FIG. 9, 1114, 1116 of FIG. 11, executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the silicon initialization instructions 206 are implemented by other hardware logic circuitry, hardware implemented state machines, and/or any other combination of hardware, software, and/or firmware. For example, the silicon initialization instructions 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for modifying the SIC extension profile 119 during runtime based on the SIC applet 106 retrieved from the software repository 105. For example, the means for modifying may be implemented by the flash image tool instructions 112 and/or the SIC applet 106. In some examples, the flash image tool instructions 112 and/or the SIC applet 106 may be implemented by machine executable instructions such as that implemented by at least blocks 702, 704, 706 of FIG. 7 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the flash image tool instructions 112 and/or the SIC applet 106 are implemented by other hardware logic circuitry, hardware implemented state machines, and/or any other combination of hardware, software, and/or firmware. For example, the flash image tool instructions 112 and/or the SIC applet 106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for generating a flash image based on the SIC applet 106. For example, the means for generating may be implemented by the flash image tool instructions 112. In some examples, the flash image tool instructions 112 may be implemented by machine executable instructions such as that implemented by at least blocks 702, 704, 706 of FIG. 7 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the flash image tool instructions 112 are implemented by other hardware logic circuitry, hardware implemented state machines, and/or any other combination of hardware, software, and/or firmware. For example, the flash image tool instructions 112 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for flashing the flash image onto the SPI flash device 114. For example, the means for flashing may be implemented by the firmware update instructions 138. In some examples, the firmware update instructions 138 may be implemented by machine executable instructions such as that implemented by at least blocks 706 of FIG. 7, 802, 804, 806 of FIG. 8 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the firmware update instructions 138 are implemented by other hardware logic circuitry, hardware implemented state machines, and/or any other combination of hardware, software, and/or firmware. For example, the firmware update instructions 138 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for enabling initialization of the processor based on the SIC extension profile 119. For example, the means for enabling may be implemented by the flash image tool instructions 112 and/or the SIC applet 106. In some examples, the flash image tool instructions 112 and/or the SIC applet 106 may be implemented by machine executable instructions such as that implemented by at least blocks 702, 704, 706 of FIG. 7 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the flash image tool instructions 112 and/or the SIC applet 106 are implemented by other hardware logic circuitry, hardware implemented state machines, and/or any other combination of hardware, software, and/or firmware. For example, the flash image tool instructions 112 and/or the SIC applet 106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for associating the SIC extension profile 119 with a performance setting for the processor. For example, the means for enabling may be implemented by the flash image tool instructions 112 and/or the SIC applet 106. In some examples, the flash image tool instructions 112 and/or the SIC applet 106 may be implemented by machine executable instructions such as that implemented by at least blocks 702, 704, 706 of FIG. 7 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the flash image tool instructions 112 and/or the SIC applet 106 are implemented by other hardware logic circuitry, hardware implemented state machines, and/or any other combination of hardware, software, and/or firmware. For example, the flash image tool instructions 112 and/or the SIC applet 106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

FIG. 12 is a block diagram of an example processor platform 1200 structured to execute and/or instantiate the machine readable instructions and/or operations of FIGS. 7, 8, 9, 10, and 122 to implement the user device 102 of FIG. 1. The processor platform 1200 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example SIC app manager, the example flash image tool, the example capsule updater, the example profile reader, and the example silicon initializer.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1232, which may be implemented by the machine readable instructions of FIGS. 7, 8, 9, 10, and 11 may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowchart of FIG. 7.

The cores 1302 may communicate by an example bus 1304. In some examples, the bus_04 may implement a communication bus to effectuate communication associated with one(s) of the cores_02. For example, the bus 1304 may implement at least one of an Inter-Integrated Circuit (I2C) bus, a Serial Peripheral Interface (SPI) bus, a PCI bus, or a PCIe bus. Additionally or alternatively, the bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and an example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The bus 1322 may implement at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 7-10 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 7-10. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 7-10. As such, the FPGA circuitry 1400 may be structured to effectively instantiate some or all of the machine readable instructions of the flowcharts of FIGS. 7-10 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 7-10 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 7-10 and/or other desired operations. The logic gate circuitryl408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 7-10 may be executed by one or more of the cores 1302 of FIG. 13 and a second portion of the machine readable instructions represented by the flowchart of FIG. 7 may be executed by the FPGA circuitry 1400 of FIG. 14.

In some examples, the processor circuitry 1212 of FIG. 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

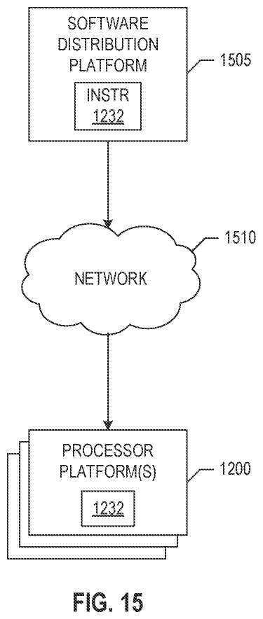

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 700 of FIGS. 7, 8, 9, 10, and 11, as described above. The one or more servers of the example software distribution platform 1505 are in communication with a network 1510, which may correspond to any one or more of the Internet and/or any of the example networks 107 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 700 of FIG. 7, may be downloaded to the example processor platform 1200, which is to execute the machine readable instructions 1232 to implement the SIC 1XX. In some example, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that facilitate firmware update and/or configuration of a platform according to user needs without the need for a firmware and/or BIOS update from an OEM. The disclosed systems, methods, apparatus, and articles of manufacture improve the efficiency of using a computing device by allowing for dynamic updates to hardware configurations based on end-user need. These updates can be made without modifying the BIOS of the user device. Additionally, the updates are performed via a trusted execution method so as not to introduce security risk to the user device. The disclosed systems, methods, apparatus, and articles of manufacture are accordingly directed to one or more improvement(s) in the operation of a machine such as a computer or other electronic and/or mechanical device.

Example apparatus, systems, and methods for initializing a processor are disclosed herein. Further examples and combinations thereof include the following:

Example 1 includes At least one non-transitory computer readable storage medium comprising instructions that, when executed, cause one or more processors to at least based on a soft strap status indicator stored in a serial peripheral interface (SPI) memory, extract a silicon initialization code profile from the SPI memory, and initialize the processor based on the silicon initialization code extension profile.

Example 2 includes the at least one non-transitory computer readable storage medium of example 1, wherein the instructions, when executed, cause the one or more processors to modify the silicon initialization code extension profile during runtime based on an applet retrieved from a remote location.

Example 3 includes the at least one non-transitory computer readable storage medium of example 1, wherein the instructions, when executed, cause the one or more processors to generate a flash image based on the applet.

Example 4 includes the at least one non-transitory computer readable storage medium of example 3, wherein the instructions, when executed, cause the one or more processors to flash the flash image into the SPI memory.

Example 5 includes the at least one non-transitory computer readable storage medium of example 2, wherein initialization of the processor based on the silicon initialization code extension profile is enabled by the applet.

Example 6 includes the at least one non-transitory computer readable storage medium of example 1, wherein the silicon initialization code extension profile includes custom hardware settings.

Example 7 includes the at least one non-transitory computer readable storage medium of example 1, wherein the silicon initialization code extension profile is associated with a performance setting for the processor.

Example 8 includes the at least one non-transitory computer readable storage medium of example 1, wherein the silicon initialization code extension profile includes a setting to indicate whether silicon initialization code extension profiles are enabled.

Example 9 includes an electronic device comprising interface circuitry to access SPI memory, extension profile handler instructions, and silicon initialization instructions, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the processor circuitry to execute the extension profile handler instructions and the silicon initialization instructions to based on a soft strap status indicator stored in the SPI memory, extract a silicon initialization code extension profile from the SPI memory, and initialize the processor circuitry based on the silicon initialization code extension profile.

Example 10 includes the electronic device of example 9, wherein the silicon initialization code extension profile is modified during runtime based on an applet retrieved from a remote location.

Example 11 includes the electronic device of example 10, wherein the processor circuitry is to generate a flash image based on the applet.

Example 12 includes the electronic device of example 11, wherein the processor circuitry is to flash the flash image into the SPI memory.

Example 13 includes the electronic device of one of examples 10-12, wherein initialization of the processor circuitry based on the silicon initialization code extension profile is enabled by the applet.

Example 14 includes the electronic device of example 9, wherein the silicon initialization code extension profile includes custom hardware settings.

Example 15 includes the electronic device of example 9, wherein the silicon initialization code extension profile is associated with a performance setting for the processor circuitry.

Example 16 includes the electronic device of example 9, wherein the silicon initialization code extension profile includes a setting to indicate whether silicon initialization code extension profiles are enabled.

Example 17 includes a method comprising extracting a silicon initialization code extension profile from a SPI memory based on a soft strap status indicator stored in the SPI memory, and initializing a processor based on the silicon initialization code extension profile.

Example 18 includes the method of example 17, further including modifying the silicon initialization code during runtime based on an applet retrieved from a remote location.

Example 19 includes the method of example 18, further including generating a flash image based on the applet.

Example 20 includes the method of example 19, further including flashing the flash image into the SPI memory.

Example 21 includes the method of example 18, further including enabling initialization of the processor based on the silicon initialization code extension profile by the applet.

Example 22 includes the method of example 17, wherein the silicon initialization code extension profile includes custom hardware settings.

Example 23 includes the method of example 17, further including associating the silicon initialization code extension profile with a performance setting for the processor.

Example 24 includes the method of example 17, wherein the silicon initialization code extension profile includes a setting to indicate whether silicon initialization code extension profiles are enabled.

Example 25 includes an apparatus comprising means for extracting a silicon initialization code extension profile from a SPI memory based on a soft strap indicator stored in the SPI memory, and means for initializing a processor based on the silicon initialization code extension profile.

Example 26 includes the apparatus of example 25, further including means for modifying the silicon initialization code extension profile during runtime based on an applet retrieved from a remote location.

Example 27 includes the apparatus of example 26, further including means for generating a flash image based on the applet.

Example 28 includes the apparatus of example 27, further including means for flashing the flash image into the SPI memory.

Example 29 includes the apparatus of example 26, further including means for enabling initialization of the processor based on the silicon initialization code extension profile.

Example 30 includes the apparatus of example 25, wherein the silicon initialization code extension profile includes custom hardware settings.

Example 31 includes the apparatus of example 25, further including means for associating the silicon initialization code extension profile with a performance setting for the processor.

Example 32 includes the apparatus of example 25, wherein the silicon initialization code extension profile includes a setting to indicate whether silicon initialization code extension profiles are enabled.

It is noted that this patent claims priority from Indian Patent Application Number 202141028575 which was filed on Jun. 25, 2021, and is hereby incorporated by reference in its entirety.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. At least one non-transitory computer readable storage medium comprising instructions that, when executed, cause one or more processors to at least:
based on a soft strap status indicator stored in a serial peripheral interface (SPI) memory, extract a silicon initialization code profile from the SPI memory; and
initialize the processor based on the silicon initialization code extension profile.

2. The at least one non-transitory computer readable storage medium of claim 1, wherein the instructions, when executed, cause the one or more processors to modify the silicon initialization code extension profile during runtime based on an applet retrieved from a remote location.

3. The at least one non-transitory computer readable storage medium of claim 1, wherein the instructions, when executed, cause the one or more processors to generate a flash image based on the applet.

4. The at least one non-transitory computer readable storage medium of claim 3, wherein the instructions, when executed, cause the one or more processors to flash the flash image into the SPI memory.

5. The at least one non-transitory computer readable storage medium of claim 2, wherein initialization of the processor based on the silicon initialization code extension profile is enabled by the applet.

6. The at least one non-transitory computer readable storage medium of claim 1, wherein the silicon initialization code extension profile includes custom hardware settings.

7. The at least one non-transitory computer readable storage medium of claim 1, wherein the silicon initialization code extension profile is associated with a performance setting for the processor.

8. The at least one non-transitory computer readable storage medium of claim 1, wherein the silicon initialization code extension profile includes a setting to indicate whether silicon initialization code extension profiles are enabled.

9. An electronic device comprising:
interface circuitry to access SPI memory;
extension profile handler instructions; and
silicon initialization instructions; and
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the processor circuitry to execute the extension profile handler instructions and the silicon initialization instructions to:
based on a soft strap status indicator stored in the SPI memory, extract a silicon initialization code extension profile from the SPI memory; and
initialize the processor circuitry based on the silicon initialization code extension profile.

10. The electronic device of claim 9, wherein the silicon initialization code extension profile is modified during runtime based on an applet retrieved from a remote location.

11. The electronic device of claim 10, wherein the processor circuitry is to generate a flash image based on the applet.

12. The electronic device of claim 11, wherein the processor circuitry is to flash the flash image into the SPI memory.

13. The electronic device of claim 10, wherein initialization of the processor circuitry based on the silicon initialization code extension profile is enabled by the applet.

14. The electronic device of claim 9, wherein the silicon initialization code extension profile includes custom hardware settings.

15. The electronic device of claim 9, wherein the silicon initialization code extension profile is associated with a performance setting for the processor circuitry.

16. The electronic device of claim 9, wherein the silicon initialization code extension profile includes a setting to indicate whether silicon initialization code extension profiles are enabled.

17. A method comprising:
extracting a silicon initialization code extension profile from a SPI memory based on a soft strap status indicator stored in the SPI memory; and
initializing a processor based on the silicon initialization code extension profile.

18. The method of claim 17, further including modifying the silicon initialization code during runtime based on an applet retrieved from a remote location.

19. The method of claim 18, further including generating a flash image based on the applet.

20. The method of claim 19, further including flashing the flash image into the SPI memory.

21. The method of claim 17, further including enabling initialization of the processor based on the silicon initialization code extension profile by the applet.

22. The method of claim 17, wherein the silicon initialization code extension profile includes custom hardware settings.

23. The method of claim 17, further including associating the silicon initialization code extension profile with a performance setting for the processor.

24. An apparatus comprising:
means for extracting a silicon initialization code extension profile from a SPI memory based on a soft strap indicator stored in the SPI memory; and
means for initializing a processor based on the silicon initialization code extension profile.

25. The apparatus of claim 24, further including means for modifying the silicon initialization code extension profile during runtime based on an applet retrieved from a remote location.
